(19) United States
(12) Patent Application Publication
(10) Pub. No.: US 2012/0033194 A1
(43) Pub. Date: Feb. 9, 2012

(54) DECISION METHOD AND STORAGE MEDIUM

(75) Inventors: Koji MIKAMI, Nikko-shi (JP); Yuichi GYODA, Utsunomiya-shi (JP); Kouichirou TSUJITA, Utsunomiya-shi (JP); Hiroyuki ISHII, Shioya-gun (JP)

(73) Assignee: CANON KABUSHIKI KAISHA, Tokyo (JP)

(21) Appl. No.: 13/198,032

(22) Filed: Aug. 4, 2011

(30) Foreign Application Priority Data
Aug. 6, 2010 (JP) 2010-178077

(51) Int. Cl. G03B 27/32

(52) U.S. Cl. 355/77

(57) ABSTRACT

The present invention provides a decision method of causing a computer to decide an exposure condition to be set in an exposure apparatus including an illumination optical system that illuminates a pattern including a plurality of pattern elements, and a projection optical system that projects the pattern onto a substrate, including a step of obtaining a distance between intersections of a first line, used to evaluate dimensions of images of the pattern elements, and contours of the images of the pattern elements by obtaining the image of the pattern formed on the image plane of the projection optical system, and a step of determining whether there exist intersections of a second line, used to evaluate whether the images of the pattern elements are resolved, and the contours of the images of the pattern elements to evaluate whether the images of the pattern elements are resolved.

### BACKGROUND OF THE INVENTION

1. Field of the Invention

The present invention relates to a decision method and a storage medium.

2. Description of the Related Art

In recent years, as semiconductor device micropatterning technology has progressed, it has become difficult to transfer (resolve) a pattern onto a substrate (for example, a wafer). In an exposure apparatus, super-resolution technologies such as modified illumination (off-axis illumination) and OPC (Optical Proximity Correction) are used to cope with the semiconductor device micropatterning. An effective light source (illumination shape) that illuminates an original (a mask or a reticle) is known to affect the pattern resolution. Japanese Patent Laid-Open No. 2009-302206 proposes a technique of sequentially setting (changing) parameters that define the effective light source for illuminating the original and evaluating (measuring) the dimension of the pattern image to be formed on the substrate, thereby deciding the effective light source optimum for the original pattern. In addition, to measure the dimension of the pattern image, “SPIE 2009 7274-033” proposes a technique of setting a plurality of evaluation lines for a pattern element to be measured and measuring the edge on the evaluation lines of a resist pattern corresponding to the pattern element by using a scanning electron microscope (SEM).

However, since the pattern resolution is affected by the effective light source, the pattern element to be measured may remain unresolved, that is, the image of the pattern element to be measured and the image of another pattern element may remain unseparated until the effective light source is decided. In the related arts, since it is impossible to correctly evaluate whether the pattern element to be measured is resolved, the dimension of the pattern image is measured based on the misrecognized edge of a resist pattern (that is, the pattern element image) corresponding to the unresolved pattern element. The present inventor has found that in such a case, since the evaluation function to be used to decide the effective light source discontinuously changes in accordance with the measurement result based on the misrecognized edge, the effective light source optimization cannot converge, and the effective light source cannot be decided.

### SUMMARY OF THE INVENTION

The present invention provides a technique advantageous in evaluating the dimension of a pattern image in consideration of whether the images of a plurality of pattern elements included in a pattern are separately formed.

According to one aspect of the present invention, there is provided a decision method of causing a computer to decide an exposure condition to be set in an exposure apparatus including an illumination optical system that illuminates a pattern including a plurality of pattern elements, and a projection optical system that projects the pattern onto a substrate, including a first step of setting a first line to be used to evaluate dimensions of images of the pattern elements on the image plane of the projection optical system, a second step of setting a second line to be used to evaluate whether the images of the pattern elements are resolved on the image plane of the projection optical system, a third step of obtaining a distance between intersections of the first line and contours of the images of the pattern elements by obtaining the image of the pattern formed on the image plane of the projection optical system, a fourth step of determining whether there exist intersections of the second line and the contours of the images of the pattern elements to evaluate whether the images of the pattern elements are resolved, a fifth step of evaluating the obtained image of the pattern by setting a value of the distance obtained in the obtaining the distance as an evaluation value upon determining, in the fourth step, that there exist no intersections, and setting an outlier different from the value of the distance obtained in the obtaining the distance as the evaluation value upon determining, in the fourth step, that there exist the intersections, and a sixth step of deciding the exposure condition based on an evaluation result in the fifth step such that the image of the pattern formed on the image plane of the projection optical system satisfies a criterion for evaluation.

Further aspects of the present invention will become apparent from the following description of exemplary embodiments with reference to the attached drawings.

### BRIEF DESCRIPTION OF THE DRAWINGS

FIG. 1 is a flowchart for explaining an evaluation method according to an embodiment of the present invention.

FIG. 2 is a view for explaining a dimension evaluation line segment and a resolution evaluation line segment according to the embodiment.

FIGS. 3A and 3B are views showing the contours of mask pattern images formed on the image plane of a projection optical system upon illuminating the mask pattern shown in FIG. 2.

FIGS. 4A and 4B are views for explaining a case in which a plurality of resolution evaluation line segments are set.

FIG. 5 is a schematic block diagram showing the arrangement of an information processing apparatus which executes a decision method according to an embodiment of the present invention.

FIG. 6 is a flowchart for explaining the decision method according to the embodiment of the present invention.

FIG. 7 is a view showing an example of a mask pattern in the decision method shown in FIG. 6.

FIG. 8 is a view for explaining parameters that define an effective light source.

FIGS. 9A to 9C are views showing the contours of mask pattern images formed on the image plane of the projection optical system upon illuminating the mask pattern shown in FIG. 7.

### DESCRIPTION OF THE EMBODIMENTS

Preferred embodiments of the present invention will be described below with reference to the accompanying drawings. Note that the same reference numerals denote the same members throughout the drawings, and a repetitive description thereof will not be given.

In this embodiment, a “dimension evaluation line segment (first line)” indicates a line segment set along the measurement direction at a place to measure the dimension on (an image formed on) the image plane of a projection optical system. A “resolution evaluation line segment (second line)” indicates a line segment set to determine whether a pattern element to be measured out of pattern elements included in a pattern is resolved. Note that “resolution” means that the image of the pattern element to be measured and the image of another pattern element are separately formed. In this embodiment, it means that the images of two pattern elements are separately formed. “Measurement” means obtaining the distance between two points of a pattern image (that is, the image of a pattern).

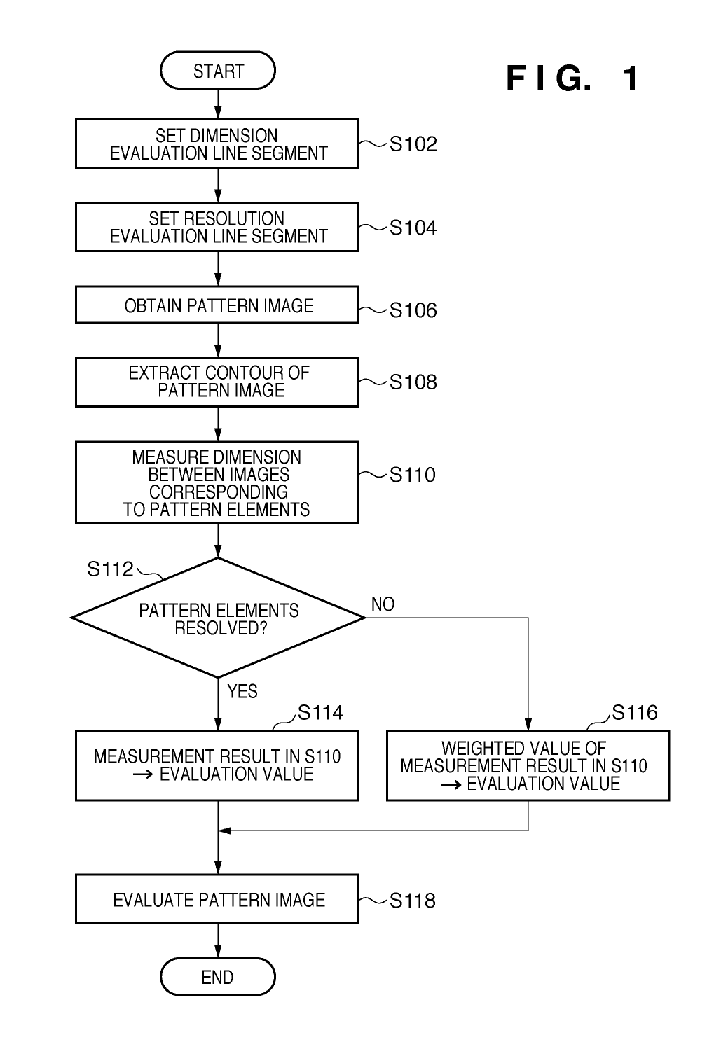

FIG. 1 is a flowchart for explaining an evaluation method according to an embodiment of the present invention. This evaluation method evaluates a pattern image formed on the image plane of a projection optical system that projects a pattern including a plurality of pattern elements onto a substrate. The evaluation method of this embodiment is implemented by, for example, supplying a program capable of executing the steps shown in FIG. 1 to an information processing apparatus (computer) via a network or a recording medium and causing the information processing apparatus to read out and execute the program stored in a storage medium such as a memory.

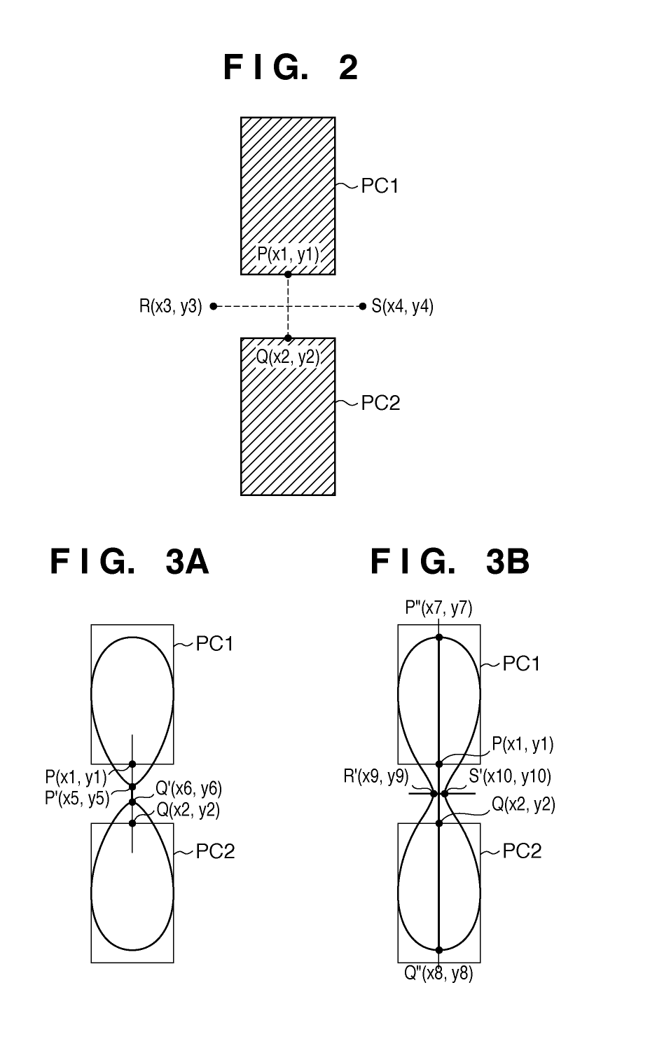

In step S102, a dimension evaluation line segment is set on the image plane of the projection optical system. More specifically, a dimension evaluation line segment is set to intersect target pattern elements on the image plane corresponding to two of a plurality of pattern elements included in a mask pattern so as to evaluate the dimension between images corresponding to the two pattern elements. In this embodiment, as shown in FIG. 2, the dimension of the end gap between a pattern element PC1 and a pattern element PC2 that are target pattern elements is measured in a mask pattern corresponding to a VLSI circuit. In this case, a line segment PQ connecting a point P(x1,y1) and a point Q(x2,y2) is set as the dimension evaluation line segment.

In step S104, a resolution evaluation line segment is set on the image plane of the projection optical system. More specifically, a resolution evaluation line segment is set between the target pattern elements to intersect the dimension evaluation line segment set in step S102 so as to evaluate whether the images of the two pattern elements are separately formed (whether the pattern elements are resolved). In this embodiment, as shown in FIG. 2, a line segment RS connecting a point R(x3,y3) and a point S(x4,y4) is set as a resolution evaluation line segment between the pattern element PC1 and the pattern element PC2 to intersect the line segment PQ serving as the dimension evaluation line segment. Note that in this embodiment, the line segment RS serving as the resolution evaluation line segment is set to be perpendicular to the line segment PQ serving as the dimension evaluation line segment at its center point (a point that equally divides the line segment PQ). However, the present invention is not limited to this. The resolution evaluation line segment may be set at any place where degradation in the pattern image resolving power along the dimension evaluation line segment conspicuously appears.

In step S106, the mask pattern image formed on the image plane of the projection optical system is obtained. The mask pattern image can be obtained by, for example, illuminating the mask pattern arranged on the object plane of the projection optical system and causing an image sensor (CCD) arranged on the image plane of the projection optical system to sense (the intensity of) light that has passed through the mask pattern. In this embodiment, the mask pattern image is obtained as image information. The image information represents the two-dimensional arrangement of the signals of the pixels of the image sensor. Note that (the image information representing) the mask pattern image can also be calculated using optical simulations.

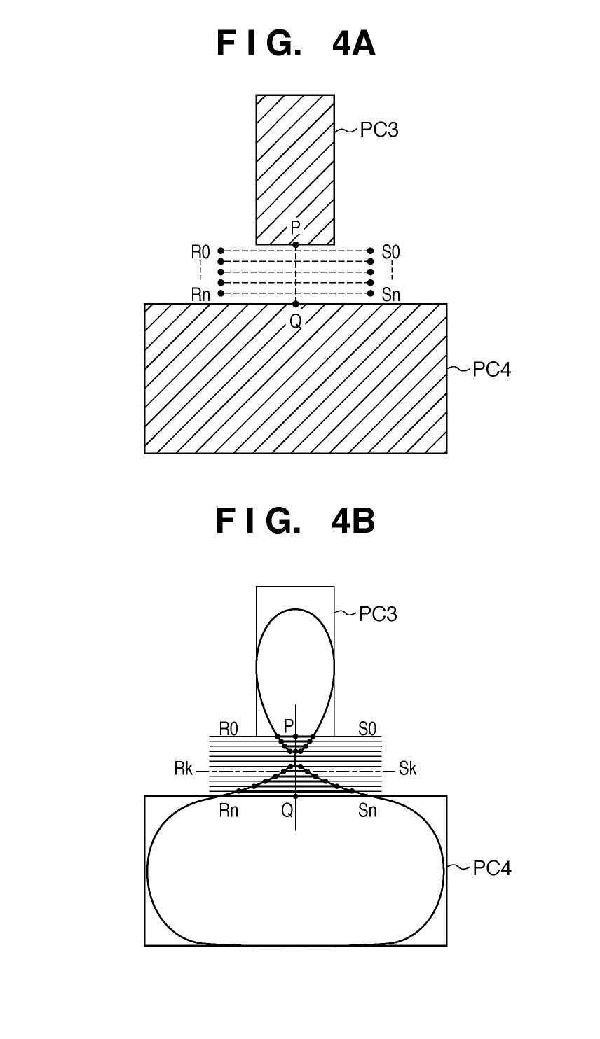

In step S108, the contour (contour image) of the mask pattern image obtained in step S106 is extracted. In this embodiment, image processing is performed to binarize the image information obtained in step S106, and the boundary line of the binary values is extracted as the contour of the mask pattern image. FIGS. 3A and 3B are views showing the contours of mask pattern images formed on the image plane of a projection optical system upon illuminating the mask pattern shown in FIG. 2. Note that FIG. 3A shows a case in which the images corresponding to the pattern elements PC1 and PC2 are separately formed (that is, the pattern elements PC1 and PC2 are resolved). FIG. 3B shows a case in which the images corresponding to the pattern elements PC1 and PC2 are not separately formed (that is, the pattern elements PC1 and PC2 are not resolved). Note that FIGS. 3A and 3B also illustrate the pattern elements PC1 and PC2 converted into the dimension on the image plane in consideration of the scaling factor of the projection optical system.

In step S110, the distance between the intersections of the dimension evaluation line segment set in step S102 and the contours of the images corresponding to the two pattern elements is obtained in the direction along the dimension evaluation line segment (that is, the dimension between the images corresponding to the two pattern elements is measured). For example, in FIG. 3A, an intersection P′(x5,y5) of (the extension line of) the line segment PQ serving as the dimension evaluation line segment and the contour of the image corresponding to the pattern element PC1 and an intersection Q′(x6,y6) of the line segment PQ and the contour of the image corresponding to the pattern element PC2 are specified first. Note that if there are two or more intersections of the line segment PQ and each of the contours of the images corresponding to the two pattern elements PC1 and PC2, two intersections closer to the center point of the line segment PQ serving as the dimension evaluation line segment are specified as the intersections of the dimension evaluation line segment and the contours of the images corresponding to the two pattern elements. As the dimension of the end gap between the pattern element PC1 and the pattern element PC2, a distance D_{P′,Q′} in the direction along the line segment PQ between the two intersections is obtained by

D_{P′D′}=\sqrt{(x5-x6)²+(y5-y6)²} (1)

On the other hand, in FIG. 3B, an intersection P″(x7,y7) of (the extension line of) the line segment PQ serving as the dimension evaluation line segment and the contour of the image corresponding to the pattern element PC1 and an intersection Q″(x8,y8) of the line segment PQ and the contour of the image corresponding to the pattern element PC2 are specified first. Then, a distance D_{P″,Q″} in the direction along the line segment PQ between the two intersections is obtained by

D_{P″Q″}=\sqrt{(x7-x8)²+(y7-y8)²} (2)

If the pattern elements PC1 and PC2 are not resolved, the distance D_{P″,Q″} is erroneously obtained as the end gap between the pattern element PC1 and the pattern element PC2 to be measured, as described above. In other words, the dimension of the mask pattern image is measured based on the misrecognized edge. As a result, the mask pattern image cannot correctly be evaluated because of the measurement result based on the misrecognized edge.

In step S112, it is evaluated (determined) whether the two pattern elements are separately formed, that is, whether the two pattern elements are resolved. More specifically, it is determined whether intersections exist of the resolution evaluation line segment set in step S104 and the contours of the images corresponding to the two pattern elements in the mask pattern image formed on the image plane of the projection optical system. For example, in FIG. 3A, since no intersections exist of the line segment RS and the contours of the images corresponding to the two pattern elements PC1 and PC2, they are determined to be resolved. On the other hand, in FIG. 3B, since intersections R′(x9,y9) and S′(x10,y10) exist of the line segment RS and the contours of the images corresponding to the two pattern elements PC1 and PC2, they are determined to be unresolved. Note that if the two pattern elements are resolved (that is, if no intersections exist), the process advances to step S114. If the two pattern elements are not resolved (that is, if intersections exist), the process advances to step S116.

In step S114, the value (the measurement result in step S110) of the distance in the direction along the dimension evaluation line segment between the intersections of the dimension evaluation line segment set in step S102 and the contours of the images corresponding to the two pattern elements is set as the evaluation value. In this embodiment, the value of the distance D_{P′,Q′} in the direction along the line segment PQ between the two intersections is set as the evaluation value when evaluating the pattern image.

In step S116, the value (the measurement result in step S110) of the distance in the direction along the dimension evaluation line segment between the intersections of the dimension evaluation line segment set in step S102 and the contours of the images corresponding to the two pattern elements is weighted and set as the evaluation value. For example, examine a case in which the dimension of the end gap between the pattern element PC1 and the pattern element PC2 that are target pattern elements is almost “0”. In this case, a value obtained by multiplying the distance D_{P″,Q″} between the two intersections in the direction along the line segment PQ by a large value such as “100” is set as the evaluation value. Alternatively, the value of the distance D_{P″,Q″} may be weighted to invalidate it when evaluating the mask pattern image (for example, the distance D_{P″,Q″} is replaced with a value representing a measurement error in advance). Note that the weighted value includes not only, for example, a value obtained by multiplying the measurement result in step S110 by a predetermined coefficient but also a value obtained by adding an offset to that value. That is, the evaluation value in step S116 need only be a numerical value (outlier) representing that the images of the two pattern elements are unresolved.

In step S118, the mask pattern image (that is, the mask pattern image obtained in step S108) formed on the image plane of the projection optical system is evaluated based on the evaluation value set in step S114 or S116.

As described above, in this embodiment, it is possible to evaluate whether the pattern elements included in the mask pattern are resolved. The mask pattern image can correctly be evaluated based on the evaluation value when the pattern elements are resolved and that when they are not resolved.

In this embodiment, the dimension between the images corresponding to the two pattern elements is measured (S110) before determining whether the two pattern elements are resolved (S112). However, the dimension between the images corresponding to the two pattern elements may be measured (S110) after determining whether the two pattern elements are resolved (S112).

In this embodiment, only one resolution evaluation line segment (line segment RS) is set in step S104. However, a plurality of resolution evaluation line segments may be set. For example, examine a case in which the dimension of the end gap between a pattern element PC3 and a pattern element PC4 that are target pattern elements is evaluated (measured) in the mask pattern shown in FIG. 4A. In this case, the line segment PQ connecting the points P and Q is set as the dimension evaluation line segment. A plurality of line segments R0S0 , . . . , RnSn are set as resolution evaluation line segments to be perpendicular to the line segment PQ at a plurality of points that equally divide the line segment PQ. FIG. 4B is a view showing the contour of the mask pattern image formed on the image plane of the projection optical system upon illuminating the mask pattern shown in FIG. 4A. Note that FIG. 4B also illustrates the pattern elements PC3 and PC4 converted into the dimension on the image plane in consideration of the scaling factor of the projection optical system. Referring to FIG. 4B, concerning the line segments indicated by bold lines out of the plurality of line segments R0S0 , . . . , RnSn, intersections with respect to the images corresponding to the pattern elements PC3 and PC4 exist. However, concerning the line segments (for example, a line segment RkSk (0≦k≦n) indicated by thin lines out of the plurality of line segments R0S0 , . . . , RnSn, no intersections exist with respect to the images corresponding to the pattern elements PC3 and PC4. Hence, a plurality of resolution evaluation line segments are generally set. In step S112, it is determined for each of the plurality of resolution evaluation line segments whether there exist intersections with respect to the contours of the images corresponding to the two pattern elements. If at least one of the plurality of resolution evaluation line segments has no intersections with respect to the contours of the images corresponding to the two pattern elements, they are determined to be resolved. On the other hand, if all of the plurality of resolution evaluation line segments have intersections with respect to the contours of the images corresponding to the two pattern elements, they are determined to be unresolved.

An example will be explained below in which the evaluation method of this embodiment is applied to a decision method of deciding exposure conditions (the effective light source and the like) to be set in an exposure apparatus including an illumination optical system for illuminating a pattern including a plurality of pattern elements, and a projection optical system for projecting the pattern onto a substrate. Note that the effective light source is the distribution of light intensities to be formed on the pupil plane of the illumination optical system.

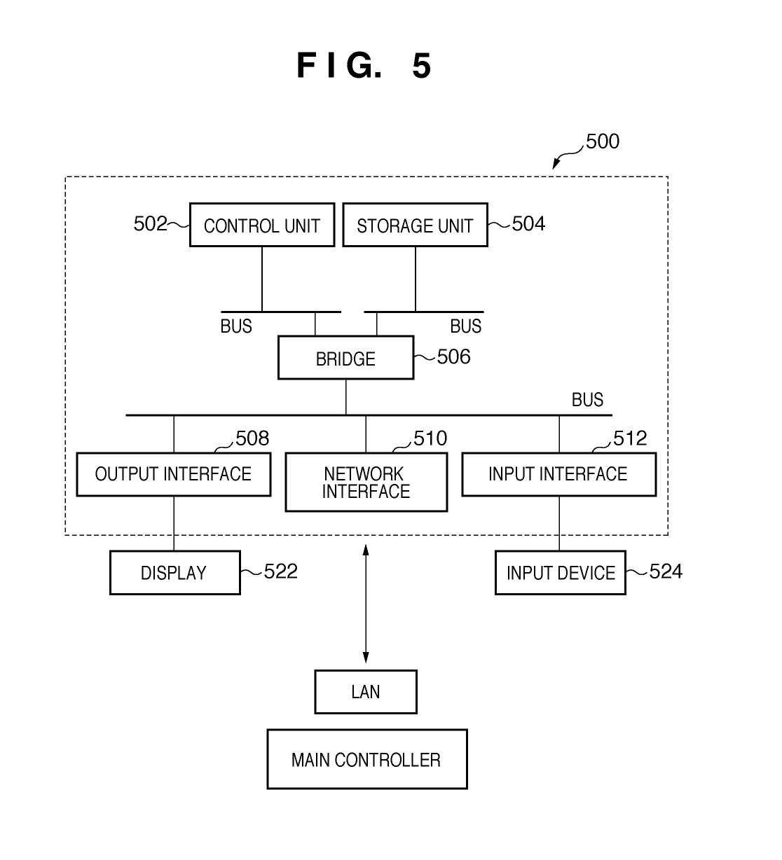

FIG. 5 is a schematic block diagram showing the arrangement of an information processing apparatus 500 which executes the decision method according to an embodiment of the present invention. The information processing apparatus 500 is an optical simulator which searches for exposure conditions with which the pattern image formed on the image plane of the projection optical system almost has the target dimension. The information processing apparatus 500 includes a control unit 502, a storage unit 504, a bridge 506, an output interface 508, a network interface 510, and an input interface 512. The control unit 502, the storage unit 504, the output interface 508, the network interface 510, and the input interface 512 are connected to the bridge 506 via buses.

A display 522 is connected to the output interface 508. An input device 524 is connected to the input interface 512. The network interface 510 is connected to a network such as a LAN to communicate data to another information processing apparatus. The main controller of the exposure apparatus and the like are also connected to the network interface 510.

The control unit 502 includes a CPU (Central Processing Unit), a DSP (Digital Signal Processor), an FPGA (Field Programmable σate Array), and a microcomputer. The storage unit 504 includes memories such as a ROM and a RAM. The input device 524 includes a mouse and a keyboard.

The control unit 502 executes programs (software codes) stored in the storage unit 504, thereby causing the information processing apparatus 500 to function as an apparatus for executing processing or a method according to the programs. The result of processing according to the programs is output to devices such as the display 522 and the main controller of the exposure apparatus via the output interface 508. The storage unit 504 stores data (layout data, data (numerical aperture (NA) and aberration information) associated with the projection optical system, and data (effective light source information and the like) associated with the illumination optical system) necessary for executing the decision method of this embodiment. These data are provided to the information processing apparatus 500 via, for example, the network interface 510 and stored in the storage unit 504.

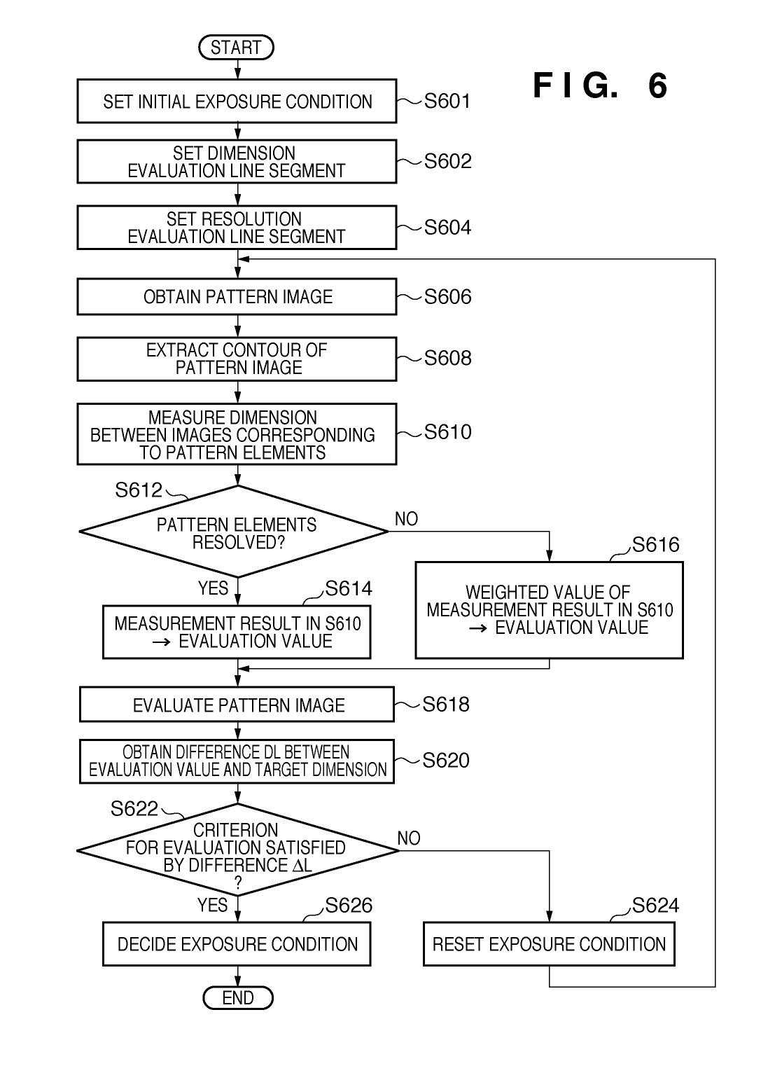

FIG. 6 is a flowchart for explaining the decision method according to the embodiment of the present invention. This decision method repeats obtaining a mask pattern image and measuring the dimension of the measurement target of the mask pattern image every time the exposure conditions change. The pattern elements included in the mask pattern may be unresolved under certain exposure conditions. However, the decision method of this embodiment can decide exposure conditions optimum for the mask pattern by correctly evaluating the mask pattern image based on the evaluation value when the pattern elements are resolved and that when they are not resolved.

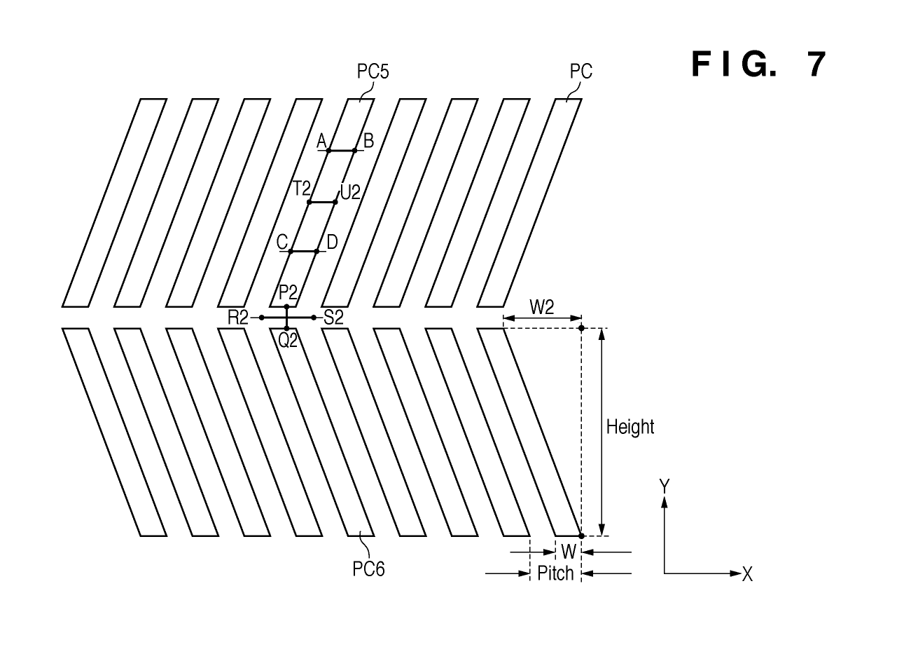

Note that in this embodiment, the mask pattern includes a plurality of pattern elements PC which are tilted with respect to the Y-axis direction and arrayed in the X-axis direction, as shown in FIG. 7. More specifically, the mask pattern shown in FIG. 7 includes nine pattern elements PC at a pitch Pitch of 100 nm, each having a line width W of 50 nm, a height Height of 400 nm, and a tilt W2 of 150 nm with respect to the Y-axis. Such a pattern can increase the number of bits per unit area of memory cells. Note that the mask is a halftone mask (halftone phase shift mask), the phase difference between the pattern elements and the background is π(180°), the transmittance of the pattern elements is 6%, and that of the background is 100%. In the mask pattern shown in FIG. 7, the short between the ends deteriorate the yield. Hence, in this embodiment, the exposure conditions are decided such that the dimension of the end gap between the pattern elements PC satisfies the criterion for evaluation.

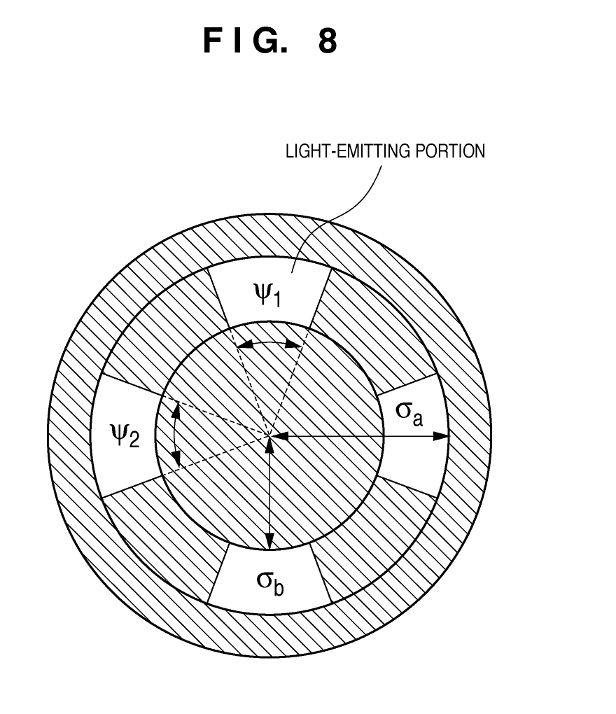

In step S601, initial exposure conditions are set. The exposure conditions are various conditions settable in an exposure apparatus when performing exposure, and include, for example, the NA of the projection optical system, the wavelength of exposure light, the type of the immersion liquid, the refractive index of the resist to be applied to the substrate, and the effective light source (illumination shape). In this embodiment, the NA of the projection optical system is 1.35, the wavelength λ of exposure light is 193 nm, the immersion liquid is pure water, the refractive index of the resist to be applied to the substrate is 1.79, and the effective light source is quadrupole illumination as the initial exposure conditions. In this embodiment, the target of exposure condition decision is the effective light source while the remaining exposure conditions such as the NA of the projection optical system and the exposure light wavelength are fixed to the initial exposure conditions. Note that parameters that define the quadrupole illumination serving as the effective light source are the σ-outer (σa), annular ratio (σratio=(σb/σa)), the aperture angle (φ1 [degree] of the pole in the X-axis direction, and the aperture angle (φ2 [degree] of the pole in the Y-axis direction, as shown in FIG. 8. These parameters can be set within the ranges of 0.7≦σa≦0.98, 0.65≦σratio 0.8, 50≦(σ1≦130, and 0≦φ2≦50, respectively. In this example, σa=0.95, σratio=0.737, (φ1=110, and (φ2=20 were set.

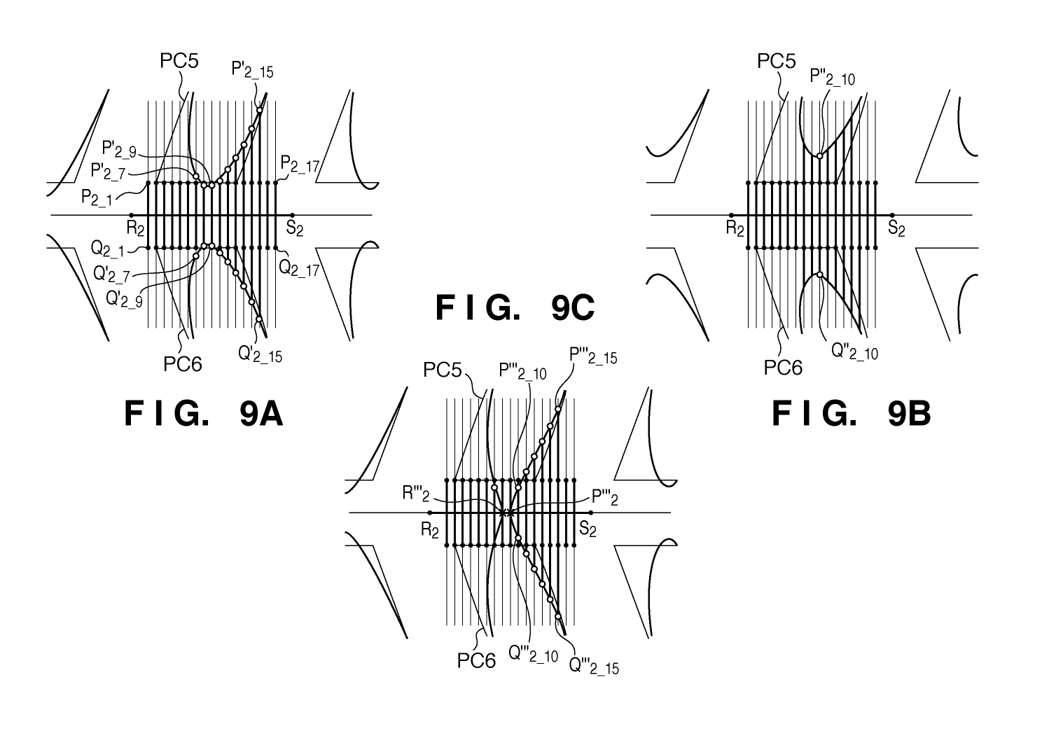

Step S602 is the same as step S102. In this embodiment, a plurality of line segments P₂_{_{—}}₁Q₂_{_{—}}₁, . . . , P₂_{_{—}}₁₇Q₂_{_{—}}₁₇ parallel to a line segment P₂Q₂ shown in FIG. 7 are set as dimension evaluation line segments (see FIGS. 9A to 9C).

Step S604 is the same as step S104. In this embodiment, a line segment R₂S₂ is set as a resolution evaluation line segment between the target pattern elements (pattern elements PC5 and PC6) to intersect the plurality of line segments (dimension evaluation line segments) P₂_{_{—}}₁Q₂_{_{—}}₁, . . . , P₂_{_{—}}₁₇Q₂_{_{—}}₁₇.

Step S606 is the same as step S106. In this embodiment, the information processing apparatus 500 executes an optical simulation to obtain, as image information, the intensity distribution (that is, the mask pattern image) the light that has passed through the mask pattern shown in FIG. 7 forms on the image plane of the projection optical system.

Step S608 is the same as step S108. In this embodiment, a slice level is decided on the intensity distribution obtained in step S606 such that a line segment T₂U₂ (see FIG. 7) has the same dimension (50 nm) as that of the mask pattern. The contour line of the intensity distribution at that time is extracted as the contour of the mask pattern image. Note that the contour of the mask pattern image is extracted without processing the intensity distribution in this case. However, the contour of the mask pattern image may be extracted after processing the intensity distribution using a process model that expresses the exposure or development characteristic of the resist.

Step S610 is the same as step S110. FIGS. 9A to 9C are views showing the contours of mask pattern images formed on the image plane of the projection optical system upon illuminating the mask pattern shown in FIG. 7. Note that FIGS. 9A and 9B illustrate cases in which the images corresponding to the pattern elements PC5 and PC6 are separately formed (that is, the pattern elements PC5 and PC6 are resolved). FIG. 9C illustrates a case in which the images corresponding to the pattern elements PC5 and PC6 are not separately formed (that is, the pattern elements PC5 and PC6 are not resolved). Note that FIGS. 9A to 9C also illustrate the pattern elements PC5 and PC6 converted into the dimension on the image plane in consideration of the scaling factor of the projection optical system.

Referring to FIG. 9A, concerning line segments P₂_{_{—}}ₖQ₂_{_{—}}ₖ (7≦k≦15) out of the plurality of line segments (dimension evaluation line segments) P₂_{_{—}}₁Q₂_{_{—}}₁, . . . , P₂_{_{—}}₁₇Q₂_{_{—}}₁₇ intersections with respect to the contours of the images corresponding to the two pattern elements PC5 and PC6 exist. First, intersections P′₂_{_{—}}ₖ, of (the extension line of) the line segments P₂_{_{—}}ₖQ₂_{_{—}}ₖ and the contour of the image corresponding to the pattern element PC5 and intersections Q₂_{_{—}}ₖof the line segments P₂_{_{—k}}Q₂_{_{—k}} and the contour of the image corresponding to the pattern element PC6 are specified. The minimum one of distances D_{P′2}_{_{—}}_{kQ′2}_{_{—}}ₖ(7≦k≦15) in the direction along the dimension evaluation line segments between the intersections of the line segment P₂_{_{—}}ₖQ₂_{_{—}}ₖ and the contours of the images corresponding to the two pattern elements PC5 and PC6 is obtained. Hence, in this embodiment, a distance D_{P′2}_{_{—}}_{9Q′2}_{_{—}}₉ is obtained as the dimension of the end gap between the pattern element PC5 and the pattern element PC6. When the exposure condition (effective light source) changes, the mask pattern image formed on the image plane of the projection optical system also changes. Hence, in FIG. 9B, a distance D_{P″2}_{_{—10}}_{Q″2}_{_{—}}₁₀ is obtained as the dimension of the end gap between the pattern element PC5 and the pattern element PC6. Note that in this embodiment, since focus is placed on the dimension of the end gap between the pattern elements, the minimum value of the measurement results of the plurality of dimension evaluation line segments is used. However, the present invention is not limited to this.

On the other hand, the mask pattern image as shown in FIG. 9C (the pattern elements PC5 and PC6 are not resolved) may be formed on the image plane of the projection optical system. Referring to FIG. 9C, concerning line segments P₂_{_{—}}ₘQ₂_{_{—}}ₘ (m=7, 10≦m≦15) out of the plurality of line segments (dimension evaluation line segments) P₂_{_{—}}₁Q₂_{_{—}}₁, . . . , P₂_{_{—}}₁₇Q₂_{_{—}}₁₇, intersections with respect to the contours of the images corresponding to the two pattern elements PC5 and PC6 exist. In FIG. 9C, a distance D_{P}′″2_{_{—}}_{10Q′″2}_{_{—}}₁₀ is obtained as the dimension of the end gap between the pattern element PC5 and the pattern element PC6. Note that the distance D_{P′″2}_{_{—}}_{10Q}′″2_{_{—}}₁₀ is not the dimension of the end gap between the pattern element PC5 and the pattern element PC6 in fact.

Step S612 is the same as step S112. In FIGS. 9A and 9B, since there exist no intersections of the line segment (resolution evaluation line segment) R₂S₂ and the contours of the images corresponding to the two pattern elements PC5 and PC6, they are determined to be resolved. In FIG. 9C, since there exist intersections R′″₂ and S′″₂ of the line segment RS and the contours of the images corresponding to the two pattern elements PC5 and PC6, they are determined to be unresolved. Note that if the two pattern elements are resolved (that is, if no intersections exist), the process advances to step S614. If the two pattern elements are not resolved (that is, if intersections exist), the process advances to step S616.

Step S614 is the same as step S114. In this embodiment, the measurement result (the distance D_{P′2}_{_{—}}_{9Q′2}_{_{—}}₉ or the distance D_{P″2}_{_{—}}_{10Q″2}_{_{—}}₁₀) in step S610 is set as the evaluation value.

Step S616 is the same as step S116. In this embodiment, the measurement result (the distance D_{P′″2}_{_{—}}_{10Q′″2}_{_{—}}₁₀) in step S610 is weighted and set as the evaluation value.

In step S618, the mask pattern image (that is, the mask pattern image obtained in step S608) formed on the image plane of the projection optical system is evaluated based on the evaluation value set in step S614 or S616.

In step S620, the difference ΔL between the evaluation value set in step S614 or S616 and the target dimension of the mask pattern is calculated based on the evaluation result in step S618. The dimension is evaluated for a plurality of line segments AB, CD, and T₂U₂, as shown in FIG. 7, although only the dimension of the end gap between the pattern elements has been described so far. Let L1 be the measurement result of the dimension of the end gap, L2, L3, and L4 be the measurement results of the plurality of line segments AB, CD, and T₂U₂, and L01, L02, L03, and L04 be the target dimensions. In this case, the difference ΔL between the evaluation value and the target dimension of the mask pattern is given by

$$Δ L = \sqrt{\frac{{( L 1 - L 01 )}^{2} + {( L 2 - L 02 )}^{2} + {( L 3 - L 03 )}^{2} + {( L 4 - L 04 )}^{2}}{4}} \qquad ( 3 )$$

In step S622, it is determined whether the difference ΔL calculated in step S620 satisfies the criterion for evaluation (that is, whether the deviation from the target dimension falls within the allowable range). If the difference ΔL does not satisfy the criterion for evaluation, the process advances to step S624. If the difference ΔL satisfies the criterion for evaluation, the process advances to step S626.

In step S624, the exposure condition is reset, and the process returns to step S606. In step S626, the initial exposure condition set in step S601 or the exposure condition reset in step S624 is decided as the exposure condition to be set in the exposure apparatus.

In this embodiment, it is possible to evaluate in this way whether the pattern elements included in the mask pattern are resolved, and thus correctly evaluate the mask pattern image based on the evaluation value when the pattern elements are resolved and that when they are not resolved. As a result, even when such an exposure condition that keeps the pattern elements unresolved until exposure condition decision is set, convergence of effective light source optimization is never impeded, and an effective light source suitable for the mask pattern can be decided.

In addition, the evaluation method of this embodiment is applicable to a technique of evaluating the dimension of a resist pattern formed on a substrate using a scanning electron microscope (SEM). There is known a technique of, when manufacturing a semiconductor device, testing the exposure margin by performing exposure while changing the exposure amount and the defocus amount in the exposure apparatus. Since the evaluation target includes a resist pattern corresponding to an unresolved pattern, applying the evaluation method of the embodiment enables correct evaluation of the exposure margin. For example, examine a case in which the dimension of a resist pattern formed on a substrate for exposure margin evaluation in correspondence with a plurality of exposure amounts and defocus amounts is continuously measured using an SEM. In this case, applying the evaluation method of the embodiment makes it possible to evaluate whether the pattern elements included in the mask pattern are resolved (that is, whether a resist pattern corresponding to the pattern elements is formed). As a result, even when the pattern elements are not resolved, the dimension of the resist pattern corresponding to the plurality of exposure amounts and defocus amounts can correctly be evaluated. It is therefore possible to correctly evaluate the exposure margin.

For the sake of comparison with the embodiment, other evaluation methods will be examined. For example, the evaluation method may be executed to determine that a pattern is not resolved when the measurement result for a dimension evaluation line segment is deviated from a reference value by a predetermined value or more. Such an evaluation method is effective for the mask pattern image shown in FIG. 3B. For the mask pattern image shown in FIG. 9C, however, it is difficult to correctly evaluate whether the pattern is resolved because the distance D_{P′″2}_{_{—}}_{10Q′″2}_{_{—}}₁₀ is not necessarily deviated from the reference value by a predetermined value or more.

The evaluation method may be executed to determine that a pattern is not resolved when the measurement results for a plurality of dimension evaluation line segments do not smoothly change with respect to the coordinates. However, it is difficult for this evaluation method to identify which has caused the change of the measurement result for the plurality of dimension evaluation line segments, the pattern shape or the unresolved pattern.

Note that when the pattern is not resolved, as shown in FIG. 3B, the intensity distribution along the dimension evaluation line segment represents “bright-dark-bright”. When the pattern is resolved, as shown in FIG. 3A, the intensity distribution along the dimension evaluation line segment represents “dark-bright-dark”. Hence, the evaluation method may be executed to evaluate, in accordance with whether the intensity near the gap is convex or concave with respect to the intensity of the contour of the pattern image, whether a pattern is resolved. In a case where there is the end gap which is resolved in a position shifted from the end gap of interest along the dimension evaluation line segment, such an evaluation method cannot perform a correct resolution evaluation, and is not suitable.

The evaluation method may be executed to evaluate, by detecting the number of mask pattern images, whether a pattern is resolved. However, it is difficult to specify the positional relationship between a dimension evaluation line segment and a resolved pattern (or an unresolved pattern).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent application No. 2010-178077 filed on Aug. 6, 2010, which is hereby incorporated by reference herein in its entirety.

What is claimed is:

1. A decision method of causing a computer to decide an exposure condition to be set in an exposure apparatus including an illumination optical system that illuminates a pattern including a plurality of pattern elements, and a projection optical system that projects the pattern onto a substrate, comprising:
a first step of setting a first line to be used to evaluate dimensions of images of the pattern elements on the image plane of the projection optical system;
a second step of setting a second line to be used to evaluate whether the images of the pattern elements are resolved on the image plane of the projection optical system;
a third step of obtaining a distance between intersections of the first line and contours of the images of the pattern elements by obtaining the image of the pattern formed on the image plane of the projection optical system;
a fourth step of determining whether there exist intersections of the second line and the contours of the images of the pattern elements to evaluate whether the images of the pattern elements are resolved;
a fifth step of evaluating the obtained image of the pattern by setting a value of the distance obtained in the obtaining the distance as an evaluation value upon determining, in the fourth step, that there exist no intersections, and setting an outlier different from the value of the distance obtained in the obtaining the distance as the evaluation value upon determining, in the fourth step, that there exist the intersections; and
a sixth step of deciding the exposure condition based on an evaluation result in the fifth step such that the image of the pattern formed on the image plane of the projection optical system satisfies a criterion for evaluation.

2. The method according to claim 1, wherein in the second step, the second line is set to intersect the first line set in the first step.

3. The method according to claim 1, wherein in the fifth step, the value of the distance obtained in the third step is weighted to invalidate the distance obtained in the third step upon determining, in the fourth step, that there exist the intersections.

4. The method according to claim 2, wherein in the second step, the second line is set to be perpendicular to the first line at a center point of the first line set in the first step.

5. The method according to claim 2, wherein
in the second step, a plurality of second lines to be used to evaluate whether the images of the pattern elements are resolved are set to be perpendicular to the first line at a plurality of points of the first line set in the first step,
in the fourth step, it is determined for each of the plurality of second lines whether there exist the intersections with respect to the contours of the images of the pattern elements, and
in the fifth step, the image of the pattern formed on the image plane of the projection optical system is evaluated by setting the value of the distance obtained in the third step as the evaluation value upon determining, in the fourth step, that there exist no intersections for at least one of the plurality of second lines, and setting a value obtained by weighting the value of the distance obtained in the third step as the evaluation value upon determining, in the fourth step, that there exist the intersections for all of the plurality of second lines.

6. The method according to claim 2, wherein
in the first step, a plurality of first lines to be used to evaluate a dimension between images corresponding to two identical pattern elements out of the plurality of pattern elements are set,
in the third step, a distance in a direction along each of the plurality of first lines is obtained between the intersections of each of the plurality of first lines and contours of the images corresponding to the two pattern elements, and
in the fifth step, the image of the pattern formed on the image plane of the projection optical system is evaluated by setting a minimum value of the distances obtained in the third step as the evaluation value upon determining, in the fourth step, that there exist no intersections.

7. The method according to claim 1, wherein the exposure condition includes a distribution of light intensities to be formed on a pupil plane of the illumination optical system.

8. A computer-readable storage medium storing a program which causes a computer to execute an evaluation method of evaluating an image of a pattern including a plurality of pattern elements, the image being formed on an image plane of a projection optical system that projects the pattern onto a substrate, the program causing the computer to execute:
a first step of setting a first line to be used to evaluate dimensions of images of the pattern elements on the image plane of the projection optical system;
a second step of setting a second line to be used to evaluate whether the images of the pattern elements are resolved on the image plane of the projection optical system;
a third step of obtaining a distance between intersections of the first line and contours of the images of the pattern elements by obtaining the image of the pattern formed on the image plane of the projection optical system;
a fourth step of determining whether there exist intersections of the second line and the contours of the images of the pattern elements to evaluate whether the images of the pattern elements are resolved; and
a fifth step of evaluating the obtained image of the pattern by setting a value of the distance obtained in the obtaining the distance as an evaluation value upon determining, in the fourth step, that there exist no intersections, and setting an outlier different from the value of the distance obtained in the obtaining the distance as the evaluation value upon determining, in the fourth step, that there exist the intersections.

9. A computer-readable storage medium storing a program which causes a computer to execute a decision method of deciding an exposure condition to be set in an exposure apparatus including an illumination optical system that illuminates a pattern including a plurality of pattern elements, and a projection optical system that projects the pattern onto a substrate, the program causing the computer to execute:
a first step of setting a first line to be used to evaluate dimensions of images of the pattern elements on the image plane of the projection optical system;
a second step of setting a second line to be used to evaluate whether the images of the pattern elements are resolved on the image plane of the projection optical system;
a third step of obtaining a distance between intersections of the first line and contours of the images of the pattern elements by obtaining the image of the pattern formed on the image plane of the projection optical system;
a fourth step of determining whether there exist intersections of the second line and the contours of the images of the pattern elements to evaluate whether the images of the pattern elements are resolved;
a fifth step of evaluating the obtained image of the pattern by setting a value of the distance obtained in the obtaining the distance as an evaluation value upon determining, in the fourth step, that there exist no intersections, and setting an outlier different from the value of the distance obtained in the obtaining the distance as the evaluation value upon determining, in the fourth step, that there exist the intersections; and
a sixth step of deciding the exposure condition based on an evaluation result in the fifth step such that the image of the pattern formed on the image plane of the projection optical system satisfies a criterion for evaluation.

10. A decision method of causing a computer to decide an exposure condition to be set in an exposure apparatus including an illumination optical system that illuminates a pattern including a plurality of pattern elements, and a projection optical system that projects the pattern onto a substrate, comprising:
a setting step of setting a temporary exposure condition;
a calculating step of calculating an image of the pattern which is formed on an image plane of the projection optical system in the temporary exposure condition;
an evaluating step of evaluating the calculated image; and
a deciding step of deciding the exposure condition based on an evaluation result in the evaluating step such that the image of the pattern formed on the image plane of the projection optical system satisfies a criterion for evaluation,
wherein the evaluation step includes a step of determining whether there exit intersections of a line to be used to evaluate whether images of the pattern elements are resolved on the image plane of the projection optical system and contours of the images of the pattern elements.
